(19) United States
(12) Patent Application Publication
(10) Pub. No.: US 2017/0348841 A1
(43) Pub. Date: Dec. 7, 2017

(54) NAIL REMOVER

(71) Applicant: Curtiss Litwiller, Coldwater, MI (US)

(72) Inventor: Curtiss Litwiller, Coldwater, MI (US)

(21) Appl. No.: 15/175,171

(22) Filed: Jun. 7, 2016

(51) Int. Cl. B25D 1/04

(52) U.S. Cl. CPC B25D 1/04

(57) ABSTRACT

A nail remover that includes: a handle, where the handle includes a proximal end and a distal end; a hammer head at the proximal end; a nail grip within the hammer head, where the nail grip is adapted to engage a nail; and a hand grip integrated into the nail grip. The hand grip includes a first position and a second position, where the first position enables use of the hammer head. The second position engages the removal of a nail.

### BACKGROUND OF THE INVENTION

### Field of Invention

The present invention relates to a nail removal device that provides a means to remove nails with little surface damage.

### Description of Related Art

Removing nails during a construction can be difficult to avoid surface damage. As it is well known nails are commonly used on carpentry to stabilize wood and paneling or another structural elements for permanent positioning. However, during a remodeling project or otherwise it may be necessary to remove nails in order to demolish, repair or remodel a particular area. People normally use crowbars or hammers to remove nails however use of such tooling usually leaves surface damages and therefore increasing the necessity for further repair work during the project. As such it would be in advantageous to have a tool that could easily and effortlessly remove a nail without damaging the exterior surface surrounding the nail.

### SUMMARY OF THE INVENTION

The present invention relates to a nail remover that includes: a handle, where the handle includes a proximal end and a distal end; a hammer head at the proximal end; a nail grip within the hammer head, where the nail grip is adapted to engage a nail; and a hand grip integrated into the nail grip. The hand grip includes a first position and a second position, where the first position enables use of the hammer head. The second position engages the removal of a nail.

### BRIEF DESCRIPTION OF DRAWINGS

FIG. 1 depicts a nail remover incorporated into a hammer in accordance with the present invention.

### DETAILED DESCRIPTION

The present invention relates to a nail remover incorporated into a conventional hammer. The present invention includes a clamp that is integrated into the head of a hammer and has a nail attachment or gripping component to grip the nail and to allow for the compression of the grip r to remove the nail without significant surface damage. The nail remover combines a vice grip configuration with a hammer to allow for the clamping of a nail and removal thereof in conjunction with the use as a hammer.

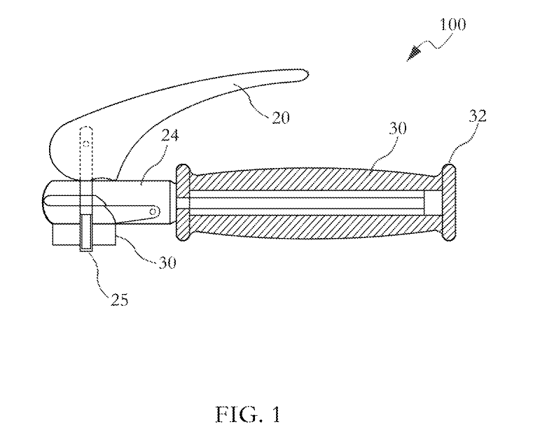

In reference to FIG. 1, a nail remover 100 in accordance with the present invention is depicted. The nail remover 100 includes a handle 30 with a distal end 32 and a proximal end 34. A grip 20 extends from the proximal end 24. This grip 20 is integrated with a nail grip 25 shown protruding through hammer head 30. Once the nail grip 25 is engaged with a nail, the user depresses the grip 20 to release the nail and to provide removal thereof. Once removed the user may then use the nail remover 100 as a hammer with hammer head 30 as shown in FIG. 3. A user depresses this handle 20 which is integrated with the nail grip 25 causing the removal of a nail during operation. Use of the present invention provides an effective and easy method to remove nails with a gripping device integrated within a hammer as shown and described above. The instant invention has been shown and described in what it considers to be the most practical and preferred embodiments. It is recognized, however, that departures may be made there from within the scope of the invention and that obvious modifications will occur to a person skilled in the art.

What is claimed is:

1. A nail remover comprising:
a. a handle, where the handle includes a proximal end and a distal end;
b. a hammer head at the proximal end;
c. a nail grip within the hammer head, where the nail grip is adapted to engage a nail; and
d. a hand grip integrated into the nail grip.

2. The nail remover according to claim 1, where the hand grip has a first position and a second position.

3. The nail remover according to claim 2, where the first position enables use of the hammer head.

4. The nail remover according to claim 2, where the second position engages the removal of a nail.
